(19) United States
(12) Patent Application Publication
(10) Pub. No.: US 2011/0022223 A1
(43) Pub. Date: Jan. 27, 2011

(54) RETROFIT DATA COMMUNICATION AT FILLING STATIONS

(75) Inventors: William S. JOHNSON, JR., Sunnyvale, CA (US); Daniel T. ROSS, Los Altos, CA (US); Paul Wayne JANNARONE, Indian Rocks Beach, FL (US); Randy Duane RICHARDSON, South Jordan, UT (US)

Correspondence Address: SUGHRUE MION, PLLC, 2100 PENNSYLVANIA AVENUE, N.W., SUITE 800, WASHINGTON, DC, 20037, US

(73) Assignee: VERIFONE, INC., San Jose, CA (US)

(21) Appl. No.: 12/837,192

(22) Filed: Jul. 15, 2010

Related U.S. Application Data
(60) Provisional application No. 61/227,171, filed on Jul. 21, 2009.
(60) Provisional application No. 61/325,531, filed on Apr. 19, 2010.

(51) Int. Cl. G06F 17/00

(52) U.S. Cl. 700/232

(57) ABSTRACT

A retrofit filling station communication system including a fuel dispensing island locatable communications adaptor assembly and a remote communications adaptor and legacy controller assembly including at least POS functionality, arranged to be coupled to existing underground wiring and to facilitate legacy and non-legacy communication at least associated with the POS functionality over the existing underground wiring with the fuel dispensing island locatable communications adaptor assembly and to facilitate legacy communication with pump control electronics via a legacy communications protocol employed by the pump control electronics prior to retrofit.

### REFERENCE TO RELATED APPLICATIONS

Reference is hereby made to U.S. Provisional Patent Application Ser. No. 61/227,171, filed Jul. 21, 2009, entitled Communications Overlay for Shared Data Streams, and U.S. Provisional Patent Application Ser. No. 61/325,531, filed Apr. 19, 2010, entitled Broadband Communication at Gas Stations, the disclosures of which are hereby incorporated by reference and priority of which is hereby claimed pursuant to 37 CFR 1.78(a) (4) and (5)(i).

### FIELD OF THE INVENTION

The present invention relates to fuel filling stations generally and more particularly to retrofit communications systems particularly suitable for fuel filling stations.

### BACKGROUND OF THE INVENTION

The following patents and Patent Publications are believed to represent the current state of the art:

U.S. Pat. Nos. 3,894,658, 3,897,887, 6,442,448 and 6,360,138; and

European Patent Publication No. EP1143388A2.

### SUMMARY OF THE INVENTION

The present invention seeks to provide retrofit communication systems for use in fuel filling stations.

There is thus provided in accordance with a preferred embodiment of the present invention a retrofit filling station communication system including a fuel dispensing island locatable communications adaptor assembly and a remote communications adaptor and legacy controller assembly including at least POS functionality, arranged to be coupled to existing underground wiring and to facilitate legacy and non-legacy communication at least associated with the POS functionality over the existing underground wiring with the fuel dispensing island locatable communications adaptor assembly and to facilitate legacy communication with pump control electronics via a legacy communications protocol employed by the pump control electronics prior to retrofit.

Preferably, the legacy communication with at least the pump control electronics via a legacy communications protocol employed by the pump control electronics prior to retrofit is directed via the fuel dispensing island locatable communications adaptor assembly. Alternatively, the legacy communication with at least the pump control electronics via a legacy communications protocol employed by the pump control electronics prior to retrofit is not directed via the fuel dispensing island locatable communications adaptor assembly.

Preferably, the fuel dispensing island locatable communications adaptor assembly also facilitates legacy communication with at least a payment device associated with the fuel dispenser on the fuel dispensing island via a legacy communications protocol employed by the payment device prior to retrofit. Additionally or alternatively, the remote communications adaptor and legacy controller assembly also includes in-store server functionality. Alternatively or additionally, the remote communications adaptor and legacy controller assembly also includes remote corporate server functionality.

In accordance with a preferred embodiment of the present invention, the fuel dispensing island locatable communications adaptor assembly and the remote communications adaptor and legacy controller assembly are arranged for legacy communication in a first frequency domain and at least some non-legacy communication in a second frequency domain, different from the first frequency domain.

Preferably, the fuel dispensing island locatable communications adaptor assembly and the remote communications adaptor and legacy controller assembly are arranged to communicate at least some payment data in a first frequency domain and at least some pump control data in a second frequency domain, different from the first frequency domain.

In accordance with a preferred embodiment of the present invention, the fuel dispensing island locatable communications adaptor assembly and the remote communications adaptor and legacy controller assembly are arranged to communicate at least some payment data and at least some pump control data over an Ethernet link. Additionally, the fuel dispensing island locatable communications adaptor assembly and the remote communications adaptor and legacy controller assembly also are arranged to communicate over a link other than an Ethernet link.

Preferably, the fuel dispensing island locatable communications adaptor assembly and the remote communications adaptor and legacy controller assembly each include a HOMEPLUG® adapter, which communicates over data lines, as opposed to power lines, of the existing underground wiring.

In accordance with a preferred embodiment of the present invention, the POS functionality includes fueling control functionality and payment control functionality.

Preferably, the remote communications adaptor and legacy controller assembly includes an in-store frequency domain multiple signal adaptor. Additionally, the in-store frequency domain multiple signal adaptor includes an Ethernet adaptor and a diplexer. Preferably, the Ethernet adaptor includes a chipset including a Media Access Control (MAC) layer and an integrated Physical (PHY) layer. Additionally or alternatively, the diplexer includes a high-pass filter, a low pass filter and impedance matching circuitry.

In accordance with a preferred embodiment of the present invention the fuel dispensing island locatable communications adaptor assembly includes a frequency domain multiple signal adaptor. Additionally, the frequency domain multiple signal adaptor includes a high-pass filter, a low pass filter and impedance matching circuitry.

Preferably, the fuel dispensing island locatable communications adaptor assembly includes an Ethernet to Dual Serial Port converter.

There is also provided in accordance with another preferred embodiment of the present invention retrofit filling station broadband communication apparatus including a fuel dispensing island locatable communications adaptor assembly, arranged to be coupled to existing underground wiring of a filling station for legacy and non-legacy communication over the existing underground wiring and a remote communications adaptor and legacy controller assembly, arranged to be coupled via the existing underground wiring and to communicate via the existing underground wiring with the fuel dispensing island locatable communications adaptor assembly, the fuel dispensing island locatable communications adaptor assembly and the remote communications adaptor and legacy controller assembly being arranged to communicate at least some legacy data in a first frequency domain and at least some non-legacy data in a second frequency domain, different from the first frequency domain.

Preferably, the remote communications adaptor and legacy controller assembly is adapted for legacy communication with at least one pump control electronics via a legacy communications protocol employed by the at least one pump control electronics prior to retrofit.

There is further provided in accordance with yet another preferred embodiment of the present invention retrofit filling station broadband communication apparatus including a fuel dispensing island locatable communications adaptor assembly, arranged to be coupled to existing underground wiring of a filling station for legacy and non-legacy communication over the existing underground wiring and to pump control electronics associated with at least one fuel dispenser on a fuel dispensing island and a remote communications adaptor and legacy controller assembly, arranged to be coupled via the existing underground wiring and to communicate via the existing underground wiring with the fuel dispensing island locatable communications adaptor assembly, the fuel dispensing island locatable communications adaptor assembly and the remote communications adaptor and legacy controller assembly being arranged to communicate at least some payment data in a first frequency domain and at least some pump control data in a second frequency domain, different from the first frequency domain.

There is yet further provided in accordance with still another preferred embodiment of the present invention retrofit filling station broadband communication apparatus including a fuel dispensing island locatable communications adaptor assembly, arranged to be coupled to existing underground wiring of a filling station for legacy and non-legacy communication over the existing underground wiring and to at least one pump control electronics associated with at least one fuel dispenser on a fuel dispensing island and a remote communications adaptor and legacy controller assembly, arranged to be coupled via the existing underground wiring and to communicate via the existing underground wiring with the fuel dispensing island locatable communications adaptor assembly, the fuel dispensing island locatable communications adaptor assembly and the remote communications adaptor and legacy controller assembly being arranged to communicate at least some payment data and at least some pump control data over an Ethernet link.

Preferably, the fuel dispensing island locatable communications adaptor assembly and the remote communications adaptor and legacy controller assembly are arranged to communicate at least some additional data over a link other than an Ethernet link.

### BRIEF DESCRIPTION OF THE DRAWINGS

The present invention will be understood and appreciated more fully from the following detailed description, taken in conjunction with the drawings in which:

FIG. 1 is a simplified partially schematic, partially block diagram illustration of a communication system useful in a fuel filling station, constructed and operative in accordance with a preferred embodiment of the present invention;

FIG. 2 is a simplified partially schematic, partially block diagram illustration of a communication system useful in a fuel filling station, constructed and operative in accordance with another referred embodiment of the present invention;

FIG. 3 is a simplified partially schematic, partially block diagram illustration of a communication system useful in a fuel filling station, constructed and operative in accordance with yet another referred embodiment of the present invention; and

FIG. 4 is a simplified partially schematic, partially block diagram illustration of a communication system useful in a fuel filling station, constructed and operative in accordance with still another referred embodiment of the present invention.

### DETAILED DESCRIPTION OF PREFERRED EMBODIMENTS

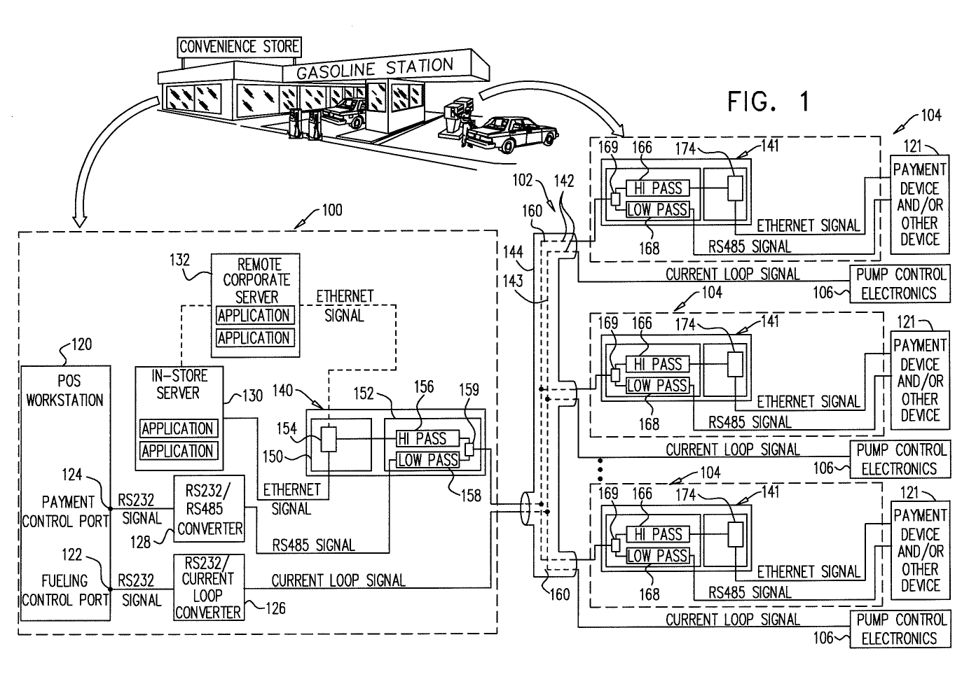

Reference is now made to FIG. 1, which is a simplified partially schematic, partially block diagram illustration of a communication system useful in a fuel filling station, constructed and operative in accordance with a preferred embodiment of the present invention.

As seen in FIG. 1, there is provided a retrofit filling station broadband communication system including a remote communications adaptor and legacy controller assembly 100, arranged to be coupled via existing underground data wiring 102 and to communicate via the existing underground wiring 102 with one or more fuel dispensing island locatable communications adaptor assemblies 104 and to pump control electronics 106 of at least one fuel dispenser on the fuel dispensing island.

Each of the fuel dispensing island locatable communications adaptor assemblies 104 is arranged to be coupled to the existing underground wiring 102 of the filling station for legacy and non-legacy communication over the existing underground wiring 102. The existing underground wiring 102 may include a hub, such as a Star Hub, and impedance matching circuitry. Alternatively, a hub, such as a Star Hub, and/or impedance matching circuitry may be additionally provided, as appropriate.

The remote communications adaptor and legacy controller assembly 100 and the one or more fuel dispensing island locatable communications adaptor assembly 104 are preferably characterized in that they communicate at least some legacy data in a first frequency domain and at least some non-legacy data in a second frequency domain, different from the first frequency domain.

Remote communications adaptor and legacy controller assembly 100 preferably includes a POS workstation 120, preferably a RUBY SuperSystem® workstation, commercially available from VeriFone, Inc. Alternatively, other POS workstations may be employed with suitable adaptations. The POS workstation 120 preferably incorporates an electronic cash register and is located within a convenience store and is used to sell gasoline and goods, as well as to control a payment device and/or other device 121 in the fuel dispensers located on the fuel dispenser island.

The POS workstation 120 is preferably provided with a fueling control port 122 having a first RS232 output and a payment control port 124 having a second RS232 output. The fueling control port 122 is preferably coupled to an RS232/current loop converter 126, such as a VeriFone SFC model P063-090-01, commercially available from VeriFone, Inc., which transforms the RS232 signal into a current loop signal and vice versa. The payment control port is preferably coupled to an RS232/RS485 converter 128, which transforms the RS232 signal into an RS485 signal and vice versa.

Preferably also located within the convenience store at the filling station is an in-store server 130, which preferably hosts various applications, such as static data, dynamic or streaming data, advertisement, remote key downloading, remote diagnostics, etc. A communications port of in-store server 130 employs a relatively high data rate signal, preferably an Ethernet signal.

Additionally, a remote corporate server 132, which preferably hosts various additional applications, such as static data, dynamic or streaming data, advertisement, remote key downloading, remote diagnostics, etc., may be provided and may communicate with in-store server 130. A communications port of remote corporate server 132 employs a relatively high data rate signal, preferably an Ethernet signal. Both the in-store server 130 and the optional remote corporate server 132 preferably provide revenue-enhancing applications, such as display advertising, and/or the ability to download new applications and software updates to the system. In this embodiment, a WAN or similar connection can provide connectivity between the corporate server 132 and the in-store server 130. Applications may reside on the corporate server 132 to push content and applications to the in-store server 130.

In accordance with a preferred embodiment of the present invention, an in-store frequency domain multiple signal adaptor 140 couples the RS485 signal from converter 128 and the communication signals from servers 130 and 132 with existing underground filling station data wiring 102 to a corresponding frequency domain multiple signal adaptor 141 associated with each fuel dispenser. The existing underground filling station data wiring 102 preferably employs twisted pairs of standard unshielded hook up wire 142 having thermoplastic high heat-resistant nylon-coated (THHN) insulation, typically formed of stranded conductors of 14AWG wire which extend through underground conduits 144.

The current loop signal from converter 126 passes along one pair of wires 142, here designated by reference numeral 143, through conduits 144 directly to fueling control electronics 106 of each fuel dispenser for legacy communication with the pump control electronics 106 via a legacy communications protocol employed by the pump control electronics 106 prior to retrofit.

The frequency domain multiple signal adaptor 140 includes two major component blocks: an Ethernet adaptor subassembly 150 and a diplexer subassembly 152. The Ethernet adaptor subassembly 150 is typically an off-the-shelf product such as a HOMEPLUG® AV Ethernet Adapter having a Coaxial Output. The use of a HOMEPLUG® adapter over data lines, as opposed to power lines, is a particular feature of the present invention.

The Ethernet adaptor subassembly 150 preferably includes a chipset 154 that provides a carrier frequency. Chipset 154 preferably includes a Media Access Control (MAC) layer and integrated Physical (PHY) layer, and provides Ethernet switching functionality. Chipset 154 converts one or more high data rate signal, such as an Ethernet signal output from in-store server 130 and/or remote corporate server 132, to an analog signal which is superimposed over a carrier signal typically carried over a coaxial connector, typically at a carrier frequency within a frequency band, such as 1-100 MHz. A preferred chipset 154 is a Intellon INT6400/INT1400 HOMEPLUG® AV commercially available from Atheros Communications, Inc. of Santa Clara, Calif.

The Ethernet signals from in-store server 130 and/or remote corporate server 132, which are typically in a frequency band of between 1-100 MHz, which are provided as the analog signal output from chipset 154, are supplied to diplexer subassembly 152, which preferably includes a high-pass filter 156, which passes generally frequencies above 1 MHz, and a low pass filter 158, which passes generally only frequencies up to 100 kHz, as well as impedance matching circuitry 159. Diplexer subassembly 152 preferably attenuates frequencies between 100 kHz to 1 MHz. The high pass filter 156 and the low pass filter 158 each preferably includes a 5 pole LC filter. The analog signal output from chipset 154 passes through the high pass filter 156 and impedance matching circuitry 159 to another pair of wires 142, here designated by reference numeral 160, which extends through conduits 144 to frequency domain multiple signal adaptors 141 associated with fuel dispensers on one or more fuel dispensing island.

It is appreciated that frequency domain multiple signal adaptors 141 associated with fuel dispensers may be identical to in-store frequency domain multiple signal adaptors 140 forming part of remote communications adaptor and legacy controller assembly 100.

The RS485 signal from converter 128, which is typically in a frequency band of less than 100 KHz, is transmitted via low pass filter 158 and impedance matching circuitry 159 along wires 160 to frequency domain multiple signal adaptors 141 associated with fuel dispensers on one or more fuel dispensing island.

It is thus appreciated that a single pair of wires 160 carries both the RS485 signals and Ethernet signals output from HOMEPLUG® AV chipset 154.

Frequency domain multiple signal adaptors 141, associated with fuel dispensers on one or more fuel dispensing island, are operative to receive the high band and low band frequency signals over wires 160 and to employ a high pass filter 166 and a low pass filter 168 as well as impedance matching circuitry 169 to separate the signals in the two bands, into an RS485 signal which is output by the low pass filter 168 and a high data rate signal, which is output from the high pass filter 166.

A chipset 174, which may be identical to chipset 154, converts the analog high data rate signal received from the high pass filter 166 to an Ethernet signal. The RS485 signal typically represents the legacy communication which is supplied to the payment device and/or other device 121 associated with the fuel dispenser. The Ethernet signal output from the chipset 174, typically representing the non-legacy communication, may be supplied to the payment device and/or other device 121, such as a display, an intercom or other customer interfaces or devices located at the fuel dispenser island.

It is appreciated that although the communication between the remote communications adaptor and legacy controller assembly 100 and the pump control electronics 106 and payment device and/or other device 121 located at the fuel dispenser island has been described in only one direction, in fact, the communication is normally bi-directional. Accordingly, the various communication assemblies, including particularly the frequency domain multiple signal adaptors 140 and 141, operate in both communication directions. This may be understood by attributing the above-described operation of frequency domain multiple signal adaptor 140 also to frequency domain multiple signal adaptors 141 and by attributing the above-described operation of frequency domain multiple signal adaptors 141 also to frequency domain multiple signal adaptor 140.

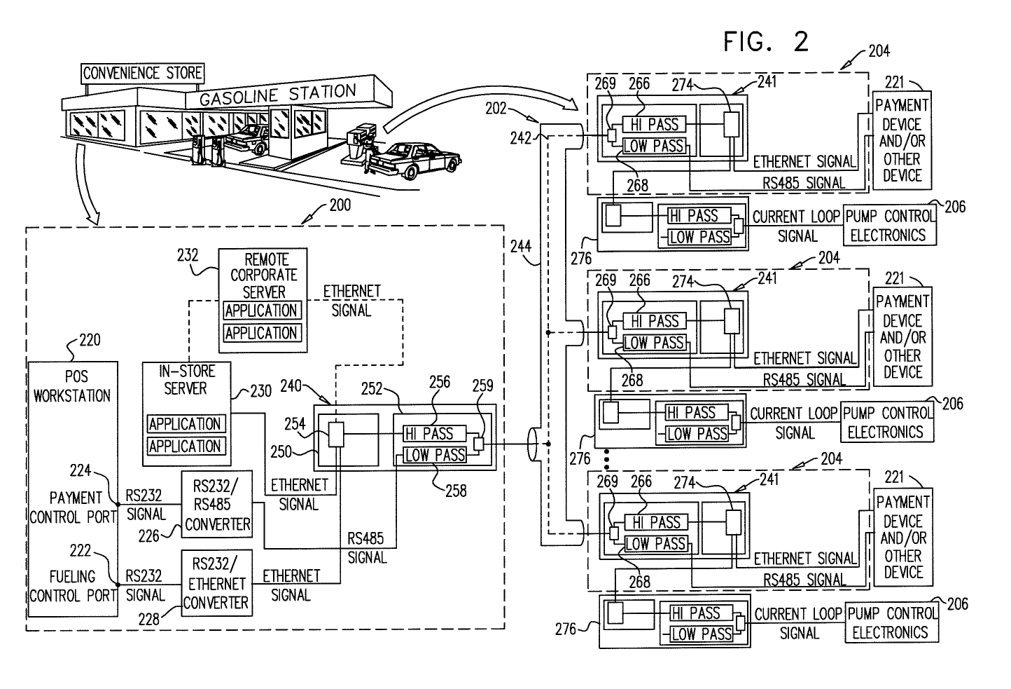

Reference is now made to FIG. 2, which is a simplified partially schematic, partially block diagram illustration of a communication system useful in a fuel filling station, constructed and operative in accordance with another preferred embodiment of the present invention.

As seen in FIG. 2, there is provided a retrofit filling station broadband communication system including a remote communications adaptor and legacy controller assembly 200, arranged to be coupled via existing underground data wiring 202 and to communicate via the existing underground wiring 202 with one or more fuel dispensing island locatable communications adaptor assemblies 204. The existing underground wiring 202 may include a hub, such as a Star Hub, and impedance matching circuitry. Alternatively, a hub, such as a Star Hub, and/or impedance matching circuitry may be additionally provided, as appropriate.

Each of the fuel dispensing island locatable communications adaptor assemblies 204 is arranged to be coupled to the existing underground wiring 202 of the filling station for legacy and non-legacy communication over the existing underground wiring 202 and to pump control electronics 206 of at least one fuel dispenser on the fuel dispensing island for legacy communication with the pump control electronics 206 via a legacy communications protocol employed by the pump control electronics 206 prior to retrofit.

The remote communications adaptor and legacy controller assembly 200 and the one or more fuel dispensing island locatable communications adaptor assembly 204 are characterized in that they communicate at least some legacy data in a first frequency domain and at least some non-legacy data in a second frequency domain, different from the first frequency domain.

Remote communications adaptor and legacy controller assembly 200 preferably includes a POS workstation 220, preferably a RUBY SuperSystem® workstation, commercially available from VeriFone, Inc. Alternatively, other POS workstations may be employed with suitable adaptations. The POS workstation 220 preferably incorporates an electronic cash register and is located within a convenience store and is used to sell gasoline and goods, as well as to control payment device and/or other device 221 in the fuel dispensers located on the fuel dispenser island.

The POS workstation 220 is preferably provided with a fueling control port 222 having a first RS232 output and a payment control port 224 having a second RS232 output. The payment control port 224 is preferably coupled to an RS232/RS485 converter 226, which transforms the RS232 signal into an RS485 signal and vice versa.

The fueling control port 222 is preferably coupled to an RS232/Ethernet converter 228, such as a VeriFone SFC P063-090-02, which transforms the RS232 signal into an Ethernet signal and vice versa.

Preferably also located within the convenience store at the filling station is an in-store server 230, which preferably hosts various applications, such as static data, dynamic or streaming data, advertisement, remote key downloading, remote diagnostics, etc. A communications port of in-store server 230 employs a relatively high data rate signal, preferably an Ethernet signal.

Additionally, a remote corporate server 232, which preferably hosts various additional applications, such as static data, dynamic or streaming data, advertisement, remote key downloading, remote diagnostics, etc., may be provided and may communicate with in-store server 230. A communications port of remote corporate server 232 employs a relatively high data rate signal, preferably an Ethernet signal. Both the in-store server 230 and the optional remote corporate server 232 preferably provide revenue-enhancing applications, such as display advertising, and/or the ability to download new applications and software updates to the system. In this embodiment, a WAN or similar connection can provide connectivity between the corporate server 232 and the in-store server 230. Applications may reside on the corporate server 232 to push content and applications to the in-store server 230.

In accordance with a preferred embodiment of the present invention, an in-store frequency domain multiple signal adaptor 240 couples the RS485 signal from converter 226 and the Ethernet signals from converter 228 and from servers 230 and 232 with existing underground filling station data wiring 202 to a corresponding frequency domain multiple signal adaptor 241 associated with each fuel dispenser. The existing underground filling station data wiring 202 preferably employs a single twisted pair 242 of standard unshielded hook up wires having THHN insulation, typically formed of stranded conductors of 14AWG wire, which extend through underground conduits 244.

The frequency domain multiple signal adaptor 240 includes two major component blocks: an Ethernet adaptor subassembly 250 and a diplexer subassembly 252. The Ethernet adaptor subassembly 250 is typically an off the shelf product such as a HOMEPLUG® AV Ethernet Adapter having a Coaxial Output. The use of a HOMEPLUG® adapter over data lines, as opposed to power lines, is a particular feature of the present invention.

The Ethernet adaptor subassembly 250 preferably includes a chipset 254 that provides a carrier frequency. Chipset 254 preferably includes a MAC layer and PHY layer, and provides Ethernet switching functionality. Chipset 254 converts one or more high data rate signal, such as the Ethernet signal outputs from converter 228, in-store server 230 and/or remote corporate server 232, to an analog signal which is superimposed over a carrier signal typically carried over a coaxial connector, typically at a carrier frequency within a frequency band, such as 1-100 MHz. A preferred chipset 254 is an Intellon INT6400/INT1400 HOMEPLUG® AV commercially available from Atheros Communications, Inc.

The Ethernet signals from in-store server 230 and/or remote corporate server 232, which are typically in a frequency band of between 2-30 MHz, which are provided as the analog signal output from chipset 254, are supplied to diplexer subassembly 252, which preferably includes a high-pass filter 256, which passes generally only frequencies above 1 MHz, and a low pass filter 258, which passes generally only frequencies up to 100 KHz, as well as impedance matching circuitry 259. Diplexer subassembly 252 preferably attenuates frequencies between 100 KHz to 1 MHz. The high pass filter 256 and the low pass filter 258 each preferably includes a 5 pole LC filter. The analog signal output from chipset 254 passes through the high pass filter 256 and impedance matching circuitry 259 to twisted pair 242, which extends through conduits 244 to frequency domain multiple signal adaptors 241.

It is appreciated that frequency domain multiple signal adaptors 241 associated with fuel dispensers may be identical to in-store frequency domain multiple signal adaptors 240 forming part of remote communications adaptor and legacy controller assembly 200.

The RS-485 signal from converter 226, which is typically in a frequency band of less than 100 KHz, is transmitted via low pass filter 258 and impedance matching circuitry 259, along wires 242, to frequency domain multiple signal adaptors 241 associated with fuel dispensers on one or more fuel dispensing island.

It is thus appreciated that a single pair of wires 242 carries both the RS485 signals and Ethernet signals output from HOMEPLUG® AV chipset 254.

Frequency domain multiple signal adaptors 241, associated with fuel dispensers on one or more fuel dispensing island, are operative to receive the high band and low band frequency signals over wires 242 and to employ a high pass filter 266 and a low pass filter 268, as well as impedance matching circuitry 269, to separate the signals in the two bands, an RS485 signal, which is output by the low pass filter 268, and a high data rate signal, which is output from the high pass filter 266.

A chipset 274, which may be identical to chipset 254, converts the analog high data rate signal received from the high pass filter 266 to an Ethernet signal. The RS485 signal typically represents the legacy communication which is supplied to the payment device and/or other device 221 associated with the fuel dispenser.

The Ethernet signal output from the chipset 274 may be supplied to payment device and/or other device 221, such as a display, an intercom or other customer interfaces or devices located at the fuel dispenser island and typically includes non-legacy communications as well as legacy communications. The Ethernet signal output from the chipset 274 which includes legacy communication is preferably addressed to an Ethernet/current loop converter 276, which may be identical to frequency domain multiple signal adaptor 240. A current loop output from converter 276 preferably supplies legacy communication to pump control electronics 206 of multiple fuel pumps.

It is appreciated that although the communication between the remote communications adaptor and legacy controller assembly 200 and the pump control electronics 206 and payment device and/or other device 221 located at the fuel dispenser island has been described in only one direction, in fact, the communication is normally bi-directional. Accordingly, the various communication assemblies, including particularly the frequency domain multiple signal adaptors 240 and 241, operate in both communication directions. This may be understood by attributing the above-described operation of frequency domain multiple signal adaptor 240 also to frequency domain multiple signal adaptors 241 and by attributing the above-described operation of frequency domain multiple signal adaptors 241 also to frequency domain multiple signal adaptor 240.

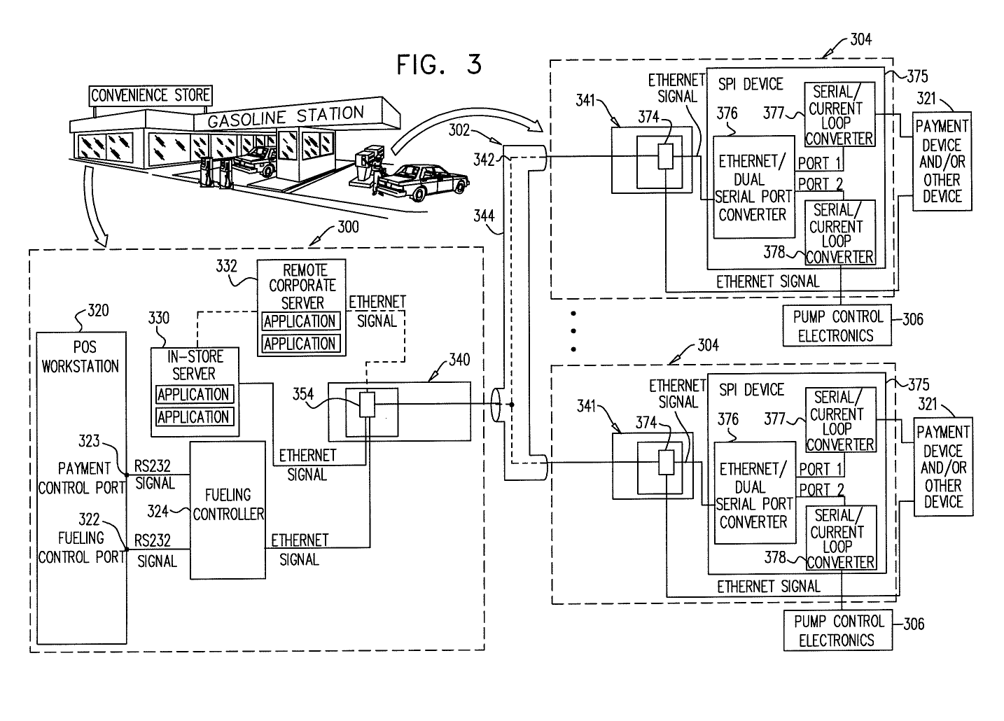

Reference is now made to FIG. 3, which is a simplified partially schematic, partially block diagram illustration of a communication system useful in a fuel filling station, constructed and operative in accordance with yet another preferred embodiment of the present invention.

As seen in FIG. 3, there is provided a retrofit filling station broadband communication system including a remote communications adaptor and legacy controller assembly 300, arranged to be coupled via existing underground data wiring 302 and to communicate via the existing underground wiring 302 with one or more fuel dispensing island locatable communications adaptor assemblies 304. The existing underground wiring 302 may include a hub, such as a Star Hub, and impedance matching circuitry. Alternatively, a hub, such as a Star Hub, and/or impedance matching circuitry may be additionally provided, as appropriate.

Each of the fuel dispensing island locatable communications adaptor assemblies 304 is arranged to be coupled to the existing underground wiring 302 of the filling station for legacy and non-legacy communication over the existing underground wiring 302 and to pump control electronics 306 of at least one fuel dispenser on the fuel dispensing island for legacy communication with the pump control electronics 306 via a legacy communications protocol employed by the pump control electronics 306 prior to retrofit.

The remote communications adaptor and legacy controller assembly 300 and the one or more fuel dispensing island locatable communications adaptor assembly 304 are characterized in that they communicate at least some legacy data in a first frequency domain and at least some non-legacy data in a second frequency domain, different from the first frequency domain.

Remote communications adaptor and legacy controller assembly 300 preferably includes a POS workstation 320, preferably a RUBY SuperSystem® workstation, commercially available from VeriFone, Inc. Alternatively, other POS workstations may be employed with suitable adaptations. The POS workstation 320 preferably incorporates an electronic cash register and is located within a convenience store and is used to sell gasoline and goods, as well as to control payment device and/or other device 321 in the fuel dispensers located on the fuel dispenser island.

The POS workstation 320 is preferably provided with a fueling control port 322 and a payment control port 323, each of which has an RS232 output. The RS232 outputs of the fueling control port 322 and payment control port 323 are preferably provided to a fueling controller 324, which is preferably a Model P063-090-01-R, commercially available from VeriFone, Inc. The fueling controller 324 preferably provides an Ethernet signal output. The fueling controller 324 is preferably operative to convert the RS232 signals to Ethernet packets, such as UDP, Point to Point UDP, broadcast packets, or other packet types, including TCP/IP. The fueling controller 324 is also preferably operative to receive Ethernet packets and to convert them to RS232 signals which may be supplied to the fueling control port 322 or the payment control port 323.

Preferably, also located within the convenience store at the filling station is an in-store server 330, which preferably hosts various applications, such as static data, dynamic or streaming data, advertisement, remote key downloading, remote diagnostics, etc. A communications port of in-store server 330 employs a relatively high data rate signal, preferably an Ethernet signal.

Additionally, a remote corporate server 332 which preferably hosts various additional applications, such as static data, dynamic or streaming data, advertisement, remote key downloading, remote diagnostics, etc., may be provided and may communicate with in-store server 330. A communications port of remote corporate server 332 employs a relatively high data rate signal, preferably an Ethernet signal. Both the in-store server 330 and the optional remote corporate server 332 preferably provide revenue-enhancing applications, such as display advertising, and/or the ability to download new applications and software updates to the system. In this embodiment, a WAN or similar connection can provide connectivity between the corporate server 332 and the in-store server 330. Applications may reside on the corporate server 332 to push content and applications to the in-store server 330.

In accordance with a preferred embodiment of the present invention an in-store Ethernet adaptor 340 adapts the communication signals from fueling controller 324 and from servers 330 and 332 for communication over existing underground filling station data wiring 302 to a corresponding Ethernet adaptor 341 associated with each fuel dispenser. The existing underground filling station data wiring 302 preferably employs a single twisted pair of standard unshielded hook up wires 342 having THHN insulation, typically formed of stranded conductors of 14AWG wire which extend through underground conduits 344.

The Ethernet adaptor 340 is typically an off the shelf product such as a HOMEPLUG® AV Ethernet Adapter having a Coaxial Output. The use of a HOMEPLUG® adapter over data lines, as opposed to power lines, is a particular feature of the present invention.

The Ethernet adaptor 340 preferably includes a chipset 354 that provides a carrier frequency. Chipset 354 preferably includes a MAC layer and PHY layer, and provides Ethernet switching functionality. Chipset 354 converts one or more high data rate signal, such as an Ethernet signal output from fueling controller 324, in-store server 330 and/or remote corporate server 332, to an analog signal which is superimposed over a carrier signal typically carried over a coaxial connector, typically at a carrier frequency within a frequency band, such as 1 to 100 MHz. A preferred chipset 354 is a INT6400/INT1400 HOMEPLUG® AV commercially available from Atheros Communications, Inc.

The analog signal output from chipset 354 passes through wires 342, which extends through conduits 344 to Ethernet adaptors 341, associated with fuel dispensers on one or more fuel dispensing island. It is appreciated that Ethernet adaptors 341 associated with fuel dispensers may be identical to in-store Ethernet adaptors 340 forming part of remote communications adaptor and legacy controller assembly 300.

Ethernet adaptors 341, associated with fuel dispensers on one or more fuel dispensing island, are operative to receive the high data rate signals and preferably include a chipset 374, which may be identical to chipset 354, which converts the analog high data rate signal received along the twisted pair of wires 342 to an Ethernet signal. The Ethernet signal output from the chipset 374 is preferably supplied to a smart pump interface (SPI) assembly 375.

The SPI assembly 375 preferably includes a Matchport® Ethernet to Dual Serial Port converter 376, preferably an off the shelf commercial device such as a Matchport® AR available from Lantronix Corporation of Irvine Calif., USA, which outputs to a pair of serial to current loop converters 377 and 378, whose outputs are, in turn, supplied to payment device and/or other device 321 and pump control electronics 306. The output of the SPI assembly 375 preferably is a current loop driver of the nonreturn to zero (NRZ) signaling type. A current loop output from converter 378 preferably supplies legacy communication to pump control electronics 306 of multiple fuel pumps.

Payment device and/or other device 321 may also receive an additional Ethernet signal output direct from chipset 374.

It is appreciated that although the communication between the remote communications adaptor and legacy controller assembly 300 and the pump control electronics 306 and payment device and/or other device 321 located at the fuel dispenser island has been described principally in only one direction, in fact, the communication is normally bi-directional. Accordingly, the various communication assemblies, including particularly the Ethernet adaptors 340 and 341, operate in both communication directions. This may be understood by attributing the above-described operation of Ethernet adaptor 340 also to Ethernet adaptors 341 and by attributing the above-described operation of Ethernet adaptors 341 also to Ethernet adaptor 340.

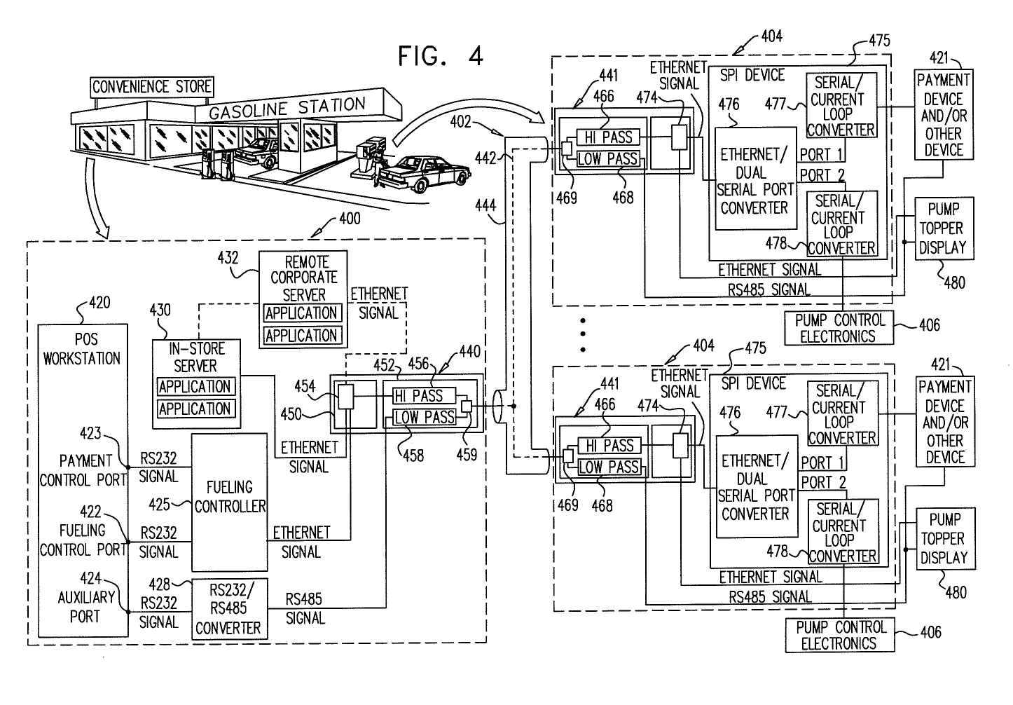

Reference is now made to FIG. 4, which is a simplified partially schematic, partially block diagram illustration of a communication system useful in a fuel filling station, constructed and operative in accordance with still another preferred embodiment of the present invention.

As seen in FIG. 4, there is provided a retrofit filling station broadband communication system including a remote communications adaptor and legacy controller assembly 400, arranged to be coupled via existing underground data wiring 402 and to communicate via the existing underground wiring 402 with one or more fuel dispensing island locatable communications adaptor assemblies 404. The existing underground wiring 402 may include a hub, such as a Star Hub, and impedance matching circuitry. Alternatively, a hub, such as a Star Hub, and/or impedance matching circuitry may be additionally provided, as appropriate.

Each of the fuel dispensing island locatable communications adaptor assemblies 404 is arranged to be coupled to the existing underground wiring 402 of the filling station for legacy and non-legacy communication over the existing underground wiring 402 and to pump control electronics 406 of at least one fuel dispenser on the fuel dispensing island for legacy communication with the pump control electronics 406 via a legacy communications protocol employed by the pump control electronics 406 prior to retrofit.

The remote communications adaptor and legacy controller assembly 400 and the one or more fuel dispensing island locatable communications adaptor assembly 404 are characterized in that they communicate at least some legacy data in a first frequency domain and at least some non-legacy data in a second frequency domain, different from the first frequency domain.

Remote communications adaptor and legacy controller assembly 400 preferably includes a POS workstation 420, preferably a RUBY SuperSystem® workstation, commercially available from VeriFone, Inc. Alternatively, other POS workstations may be employed with suitable adaptations. The POS workstation 420 preferably incorporates an electronic cash register and is located within a convenience store and is used to sell gasoline and goods, as well as to control a payment device and/or other device 421 in the fuel dispensers located on the fuel dispenser island.

The POS workstation 420 is preferably provided with a fueling control port 422, a payment control port 423 and an auxiliary port 424, each of which has an RS232 output. The RS232 outputs of the fueling control port 422 and payment control port 423 are preferably provided to a fueling controller 425, which is preferably a Model P063-090-01-R, commercially available from VeriFone, Inc. The fueling controller 425 preferably provides an Ethernet signal output. The fueling controller 425 is preferably operative to convert the RS232 signals to Ethernet packets, such as UDP, Point to Point UDP, broadcast packets, or other packet types, including TCP/IP. The fueling controller 425 is also preferably operative to receive Ethernet packets and to convert them to RS232 signals which may be supplied to the fueling control port 422 and/or the payment control port 423.

The RS232 output of the auxiliary port 424 is preferably coupled to an RS232/RS485 converter 428, which transforms the RS232 signal into an RS485 signal and vice versa.

Preferably, also located within the convenience store at the filling station is an in-store server 430, which preferably hosts various applications, such as static data, dynamic or streaming data, advertisement, remote key downloading, remote diagnostics, etc. A communications port of in-store server 430 employs a relatively high data rate signal, preferably an Ethernet signal.

Additionally, a remote corporate server 432 which preferably hosts various additional applications, such as static data, dynamic or streaming data, advertisement, remote key downloading, remote diagnostics, etc., may be provided and may communicate with in-store server 430. A communications port of remote corporate server 432 employs a relatively high data rate signal, preferably an Ethernet signal. Both the in-store server 430 and the optional remote corporate server 432 preferably provide revenue-enhancing applications, such as display advertising, and/or the ability to download new applications and software updates to the system. In this embodiment, a WAN or similar connection can provide connectivity between the corporate server 432 and the in-store server 430. Applications may reside on the corporate server 432 to push content and applications to the in-store server 430.

In accordance with a preferred embodiment of the present invention, an in-store frequency domain multiple signal adaptor 440 couples the RS485 signal from converter 428 and the communication signals from fueling controller 425 and from servers 430 and 432 with existing underground filling station data wiring 402 to a corresponding frequency domain multiple signal adaptor 441 associated with each fuel dispenser. The existing underground filling station data wiring 402 preferably employs a single twisted pair 442 of standard unshielded hook up wire having THHN insulation, typically formed of stranded conductors of 14AWG wire which extend through underground conduits 444.

The frequency domain multiple signal adaptor 440 includes two major component blocks: an Ethernet adaptor subassembly 450 and a diplexer subassembly 452. The Ethernet adaptor subassembly 450 is typically an off the shelf product such as a HOMEPLUG® AV Ethernet Adapter having a Coaxial Output. The use of a HOMEPLUG® adapter over data lines, as opposed to power lines, is a particular feature of the present invention.

The Ethernet adaptor subassembly 450 preferably includes a chipset 454 that provides a carrier frequency. Chipset 454 preferably includes a MAC layer and PHY layer, and provides Ethernet switching functionality. Chipset 454 converts one or more high data rate signal, such as an Ethernet signal output from fueling controller 425, in-store server 430 and/or remote corporate server 432, to an analog signal which is superimposed over a carrier signal typically carried over a coaxial connector, typically at a carrier frequency within a frequency band, such as 1-100 MHz. A preferred chipset 454 is an Intellon INT6400/INT1400 HOMEPLUG® AV commercially available from Atheros Communications, Inc.

The Ethernet signals from fueling controller 425, in-store server 430 and/or remote corporate server 432, which are typically in a frequency band of between 2-30 MHz, which are provided as the analog signal output from chipset 454, are supplied to diplexer subassembly 452, which preferably includes a high-pass filter 456, which passes generally only frequencies above 1 MHz, and a low pass filter 458, which passes generally only frequencies below 100 kHz, as well as impedance matching circuitry 459. Diplexer subassembly 452 preferably attenuates frequencies between 100 kHz to 1 MHz. The high pass filter 456 and the low pass filter 458 each preferably includes a 5 pole LC filter. The analog signal output from chipset 454 passes through the high pass filter 456 via impedance matching circuitry 459, to twisted pair 442, which extends through conduits 444, to frequency domain multiple signal adaptors 441.

It is appreciated that frequency domain multiple signal adaptors 441 associated with fuel dispensers may be identical to in-store frequency domain multiple signal adaptors 440 forming part of remote communications adaptor and legacy controller assembly 400.

The RS-485 signal from converter 428, which is typically in a frequency band of less than 100 KHz, is transmitted via low pass filter 458 via impedance matching circuitry 459 along twisted pair 442 to frequency domain multiple signal adaptors 441 associated with fuel dispensers on one or more fuel dispensing island.

It is thus appreciated that a single twisted pair 442 of wires carries both the RS485 signals and Ethernet signals output from HOMEPLUG® AV chipset 454.

Frequency domain multiple signal adaptors 441, associated with fuel dispensers on one or more fuel dispensing island, are operative to receive the high band and low band frequency signals over wires 442 and to employ a high pass filter 466 and a low pass filter 468 to separate the signals in the two bands, an RS485 signal, which is output by the low pass filter 468, and a high data rate signal, which is output from the high pass filter 466, via impedance matching circuitry 469.

A chipset 474, which may be identical to chipset 454, converts the analog high data rate signal received from the high pass filter 466 to an Ethernet signal. The RS485 signal typically represents the legacy communication which is supplied to the payment device and/or other device 421 associated with the fuel dispenser. The Ethernet signal output from the chipset 474 is preferably supplied to a smart pump interface (SPI) assembly 475.

The SPI assembly 475 preferably includes a Matchport® Ethernet to Dual Serial Port converter 476, preferably an off the shelf commercial device, such as a Matchport® AR, available from Lantronix Corporation of Irvine, Calif. USA, which outputs to a pair of serial/current loop converters 477 and 478. The output of converter 477 is preferably supplied to payment device and/or other device 421. The output of converter 478, typically representing legacy communication, is preferably supplied to pump control electronics 406. The output of the SPI assembly 475 preferably is a current loop driver of the NRZ signaling type.

A pump topper display 480 may receive an additional Ethernet signal output direct from chipset 474 and an RS485 signal which is output by the low pass filter 468 via impedance matching circuitry 469. The Ethernet signals and the RS485 signals may carry both legacy and non-legacy communications.

It is appreciated that although the communication between the remote communications adaptor and legacy controller assembly 400 and the pump control electronics 406, payment device and/or other device 421 and pump topper display 480 located at the fuel dispenser island has been described principally in only one direction, in fact, the communication is normally bi-directional. Accordingly, the various communication assemblies, including particularly the frequency domain multiple signal adaptors 440 and 441, operate in both communication directions. This may be understood by attributing the above-described operation of frequency domain multiple signal adaptor 440 also to frequency domain multiple signal adaptors 441 and by attributing the above-described operation of frequency domain multiple signal adaptors 441 also to frequency domain multiple signal adaptor 440.

It will be appreciated by persons skilled in the art that the present invention is not limited by what has been particularly shown and described hereinabove. Rather, the invention also includes various combinations and subcombinations of the features described hereinabove as well as modifications and variations thereof, which would occur to persons skilled in the art upon reading the foregoing and which are not in the prior art.

1. A retrofit filling station communication system comprising:
a fuel dispensing island locatable communications adaptor assembly; and
a remote communications adaptor and legacy controller assembly including at least POS functionality, arranged to be coupled to existing underground wiring and to facilitate legacy and non-legacy communication at least associated with said POS functionality over said existing underground wiring with said fuel dispensing island locatable communications adaptor assembly and to facilitate legacy communication with pump control electronics via a legacy communications protocol employed by said pump control electronics prior to retrofit.

2. A retrofit filling station communication system according to claim 1 and wherein said legacy communication with at least said pump control electronics via a legacy communications protocol employed by said pump control electronics prior to retrofit is directed via said fuel dispensing island locatable communications adaptor assembly.

3. A retrofit filling station communication system according to claim 1 and wherein said legacy communication with at least said pump control electronics via a legacy communications protocol employed by said pump control electronics prior to retrofit is not directed via said fuel dispensing island locatable communications adaptor assembly.

4. A retrofit filling station communication system according to claim 1 and wherein said fuel dispensing island locatable communications adaptor assembly also facilitates legacy communication with at least a payment device associated with said fuel dispenser on said fuel dispensing island via a legacy communications protocol employed by said payment device prior to retrofit.

5. A retrofit filling station communication system according to claim 1 and wherein said remote communications adaptor and legacy controller assembly also includes in-store server functionality.

6. A retrofit filling station communication system according to claim 4 and wherein said remote communications adaptor and legacy controller assembly also includes in-store server functionality.

7. A retrofit filling station communication system according to claim 1 and wherein said remote communications adaptor and legacy controller assembly also includes remote corporate server functionality.

8. A retrofit filling station communication system according to claim 4 and wherein said remote communications adaptor and legacy controller assembly also includes remote corporate server functionality.

9. A retrofit filling station communication system according to claim 1 and wherein said fuel dispensing island locatable communications adaptor assembly and said remote communications adaptor and legacy controller assembly are arranged for legacy communication in a first frequency domain and at least some non-legacy communication in a second frequency domain, different from said first frequency domain.

10. A retrofit filling station communication system according to claim 1 and wherein said fuel dispensing island locatable communications adaptor assembly and said remote communications adaptor and legacy controller assembly are arranged to communicate at least some payment data in a first frequency domain and at least some pump control data in a second frequency domain, different from said first frequency domain.

11. A retrofit filling station communication system according to claim 1 and wherein said fuel dispensing island locatable communications adaptor assembly and said remote communications adaptor and legacy controller assembly are arranged to communicate at least some payment data and at least some pump control data over an Ethernet link.

12. A retrofit filling station communication system according to claim 11 and wherein said fuel dispensing island locatable communications adaptor assembly and said remote communications adaptor and legacy controller assembly also are arranged to communicate over a link other than an Ethernet link.

13. A retrofit filling station communication system according to claim 1 and wherein said fuel dispensing island locatable communications adaptor assembly and said remote communications adaptor and legacy controller assembly each include a HOMEPLUG® adapter, which communicates over data lines, as opposed to power lines, of said existing underground wiring.

14. A retrofit filling station communication system according to claim 1 and wherein said POS functionality includes fueling control functionality and payment control functionality.

15. A retrofit filling station communication system according to claim 1 and wherein said remote communications adaptor and legacy controller assembly comprises an in-store frequency domain multiple signal adaptor.

16. A retrofit filling station communication system according to claim 15 and wherein said in-store frequency domain multiple signal adaptor comprises an Ethernet adaptor and a diplexer.

17. A retrofit filling station communication system according to claim 16 and wherein said Ethernet adaptor comprises a chipset including a Media Access Control (MAC) layer and an integrated Physical (PHY) layer.

18. A retrofit filling station communication system according to claim 16 and wherein said diplexer comprises a high-pass filter, a low pass filter and impedance matching circuitry.

19. A retrofit filling station communication system according to claim 1 and wherein said fuel dispensing island locatable communications adaptor assembly comprises a frequency domain multiple signal adaptor.

20. A retrofit filling station communication system according to claim 19 and wherein said frequency domain multiple signal adaptor comprises a high-pass filter, a low pass filter and impedance matching circuitry.

21. A retrofit filling station communication system according to claim 1 and wherein said fuel dispensing island locatable communications adaptor assembly comprises an Ethernet to Dual Serial Port converter.

22. Retrofit filling station broadband communication apparatus comprising:
a fuel dispensing island locatable communications adaptor assembly, arranged to be coupled to existing underground wiring of a filling station for legacy and non-legacy communication over said existing underground wiring; and
a remote communications adaptor and legacy controller assembly, arranged to be coupled via said existing underground wiring and to communicate via said existing underground wiring with said fuel dispensing island locatable communications adaptor assembly,
said fuel dispensing island locatable communications adaptor assembly and said remote communications adaptor and legacy controller assembly being arranged to communicate at least some legacy data in a first frequency domain and at least some non-legacy data in a second frequency domain, different from said first frequency domain.

23. Retrofit filling station broadband communication apparatus according to claim 22 and wherein said remote communications adaptor and legacy controller assembly is adapted for legacy communication with at least one pump control electronics via a legacy communications protocol employed by said at least one pump control electronics prior to retrofit.

24. Retrofit filling station broadband communication apparatus comprising:
a fuel dispensing island locatable communications adaptor assembly, arranged to be coupled to existing underground wiring of a filling station for legacy and non-legacy communication over said existing underground wiring and to pump control electronics associated with at least one fuel dispenser on a fuel dispensing island; and
a remote communications adaptor and legacy controller assembly, arranged to be coupled via said existing underground wiring and to communicate via said existing underground wiring with said fuel dispensing island locatable communications adaptor assembly,
said fuel dispensing island locatable communications adaptor assembly and said remote communications adaptor and legacy controller assembly being arranged to communicate at least some payment data in a first frequency domain and at least some pump control data in a second frequency domain, different from said first frequency domain.

25. Retrofit filling station broadband communication apparatus comprising:
a fuel dispensing island locatable communications adaptor assembly, arranged to be coupled to existing underground wiring of a filling station for legacy and non-legacy communication over said existing underground wiring and to at least one pump control electronics associated with at least one fuel dispenser on a fuel dispensing island; and
a remote communications adaptor and legacy controller assembly, arranged to be coupled via said existing underground wiring and to communicate via said existing underground wiring with said fuel dispensing island locatable communications adaptor assembly,
said fuel dispensing island locatable communications adaptor assembly and said remote communications adaptor and legacy controller assembly being arranged to communicate at least some payment data and at least some pump control data over an Ethernet link.

26. Retrofit filling station broadband communication apparatus according to claim 25 and wherein said fuel dispensing island locatable communications adaptor assembly and said remote communications adaptor and legacy controller assembly are arranged to communicate at least some additional data over a link other than an Ethernet link.
